(19) United States
(12) Patent Application Publication
(10) Pub. No.: US 2004/0218216 A1
(43) Pub. Date: Nov. 4, 2004

(54) Character string edition apparatus and character string edition program

(76) Inventors: Chitoshi Ito, Kasugai-shi (JP); Kazuhiko Iwanaga, Nagoya-shi (JP); Tatsuhiro Ikedo, Ena-shi (JP)

Correspondence Address: Oliff & Berridge, PO Box 19928, Alexandria, VA, 22320, US

(21) Appl. No.: 10/488,886

(22) PCT Filed: Sep. 4, 2002
(86) PCT No.: PCT/JP02/08970

(30) Foreign Application Priority Data
Sep. 7, 2001 (JP) 2001-271739

(51) Int. Cl. G06F 15/00; H04N 1/46

(52) U.S. Cl. 358/1.18; 358/1.5; 358/537

(57) ABSTRACT

When a character key is pressed for inputting a character (S103: YES), the inputted character is stored in RAM so that the character will be inserted into the position of a caret in a character string (S105). The size of each character is determined based on the length of the character string containing the added character, etc., while the length of a tape image is changed based on the determined character size and the number of lines of the character strings so that the whole character string can be accommodated in the tape image (S106). When the caret goes out of a display range (S108: NO), the tape image is moved so that the caret will be within the display range (S109), by which the operator is allowed to easily check actual layout of a printed tape without the need of performing a complicated manual operation.

### TECHNICAL FIELD

The present invention relates to a character string editing device and a character string editing program which are used for editing a character string to be formed on an image formation medium.

### BACKGROUND OF THE INVENTION

Tape printers, for printing a character string of an arbitrary length on a tape being unrolled from a roll of long tape and fed by a motor, are well known. In the editing of the character string to be printed by the tape printer, not only the character string inputted through a keyboard, etc. but also an image of the tape (on which the character string will be printed) is in some cases displayed on a display of the tape printer as the background to the character string, in order to let the operator easily grasp how the character, string will actually be printed on the tape.

### DISCLOSURE OF THE INVENTION

In such a character string editing device capable of displaying the character string together with the tape image, the length of the tape image displayed on the display is fixed regardless of the length of the character string. Thus, it is difficult for the operator to previously check and recognize actual layout of the printed tape. Further, when a long character string exceeding the fixed tape image length is inputted, even though the tape image automatically scrolls so as to display a caret (indicating a character insertion point in the tape image) within the tape image, the operator needs to perform a complicated manual operation (manually enlarging the tape image, moving the caret by operating the keyboard, mouse, etc.) in order to see characters that are not displayed in the tape image.

It is therefore the object of the present invention to provide a character string editing device and a character string editing program capable of letting the operator easily check the actual layout of the printed tape without the need of performing a complicated manual operation regardless of the length of the inputted character string.

A character string editing device according to the invention is a character string editing device for editing a character string to be formed on an image formation medium, the device including: a medium display control means which controls displaying of an image of the image formation medium on a display; a character string storage means for storing one or more lines of character string; a character string display control means which controls displaying of the one or more lines of character string stored in the character string storage means in the image displayed on the display; and a medium length control means for controlling the medium display control means so that the image will expand and contract depending on the length of the longest character string in the one or more lines of character string stored in the character string storage means.

According to the invention, since the image of the image formation medium expands or contracts to a proper length corresponding to the length of the character string, the operator is allowed to easily check the actual layout of the printed tape without the need of performing a complicated manual operation regardless of the length of the inputted character string.

### BRIEF DESCRIPTION OF THE DRAWINGS

FIG. 1 is a perspective view showing the outline of a personal computer which functions as a character string editing device in accordance with an embodiment of the present invention and a printer;

FIG. 2 is a plan view for explaining the structure of a printing mechanism and a tape cassette which are installed in the printer shown in FIG. 1;

FIG. 3 is a block diagram for explaining a control system of the computer shown in FIG. 1;

FIG. 4 is a block diagram for explaining the operation of a CPU of the computer having the control system shown in FIG. 3;

FIG. 5 is a flow chart for explaining the operation of the CPU shown in FIG. 4;

FIG. 6 is a schematic diagram showing an example of an edit screen and a tape image which are displayed on a liquid crystal display of the personal computer shown in FIG. 1 when a moving end is set to be a right end only;

FIG. 7 is a schematic diagram showing an example of the edit screen and the tape image with its moving end being set to be the right end only similarly to FIG. 6;

FIG. 8 is a schematic diagram showing an example of the edit screen and the tape image with its moving end being set to be the right end only similarly to FIG. 6;

FIG. 9 is a schematic diagram showing an example of the edit screen and the tape image with its right end designated as the moving end similarly to FIG. 6;

FIG. 10 is a schematic diagram showing an example of the edit screen and the tape image with its moving end being set to be the right end only similarly to FIG. 6;

FIG. 11 is a schematic diagram showing an example of the edit screen and the tape image with its moving end being set to be the right end only similarly to FIG. 6;

FIG. 12 is a schematic diagram showing an example of the edit screen and the tape image which are displayed on the LCD of the personal computer shown in FIG. 1 when the moving end is set to be a left end only;

FIG. 13 is a schematic diagram showing an example of the edit screen and the tape image with its moving end being set to be the left end only similarly to FIG. 12;

FIG. 14 is a schematic diagram showing an example of the edit screen and the tape image with its moving end being set to be the left end only similarly to FIG. 12;

FIG. 15 is a schematic diagram showing an example of the edit screen and the tape image with its moving end being set to be the left end only similarly to FIG. 12;

FIG. 16 is a schematic diagram showing an example of the edit screen and the tape image with its moving end being set to be the left end only similarly to FIG. 12;

FIG. 17 is a schematic diagram showing an example of the edit screen and the tape image which are displayed on the LCD of the personal computer shown in FIG. 1 when the moving end is set to be both right-and-left ends;

FIG. 18 is a schematic diagram showing an example of the edit screen and the tape image with its moving end being set to be both right-and-left ends similarly to FIG. 17;

FIG. 19 is a schematic diagram showing an example of the edit screen and the tape image with its moving end being set to be both right-and-left ends similarly to FIG. 17; and

FIG. 20 is a schematic diagram showing an example of the edit screen and the tape image with its moving end being set to be both right-and-left ends similarly to FIG. 17.

### BEST MODE FOR CARRYING OUT THE INVENTION

Referring now to the drawings, a description will be given in detail of preferred embodiments in accordance with the present invention.

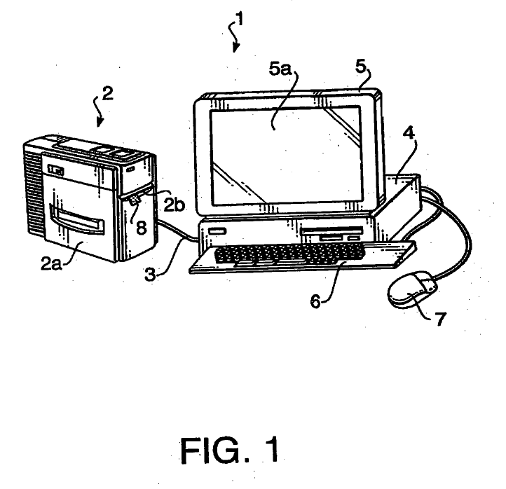

FIG. 1 is a perspective view showing the outline of a personal computer which functions as a character string editing device in accordance with an embodiment of the present invention (hereinafter referred to as “computer”) and a printer. As shown in FIG. 1, the computer 1 and the printer 2 are connected to each other by a cable 3 so as to communicate data via the cable 3.

As shown in FIG. 1, the computer 1 includes a control main body 4 including a CPU (Central Processing Unit), RAM (Random Access Memory), etc., a liquid crystal display 5 having a display part (liquid crystal panel) 5a, a keyboard 6 having a lot of keys such as character keys and control keys on top of it, and a mouse 7 for designating and inputting a particular coordinate on the liquid crystal panel 5a. The liquid crystal display 5, keyboard 6 and mouse 7 are connected to the control main body 4 by cables respectively.

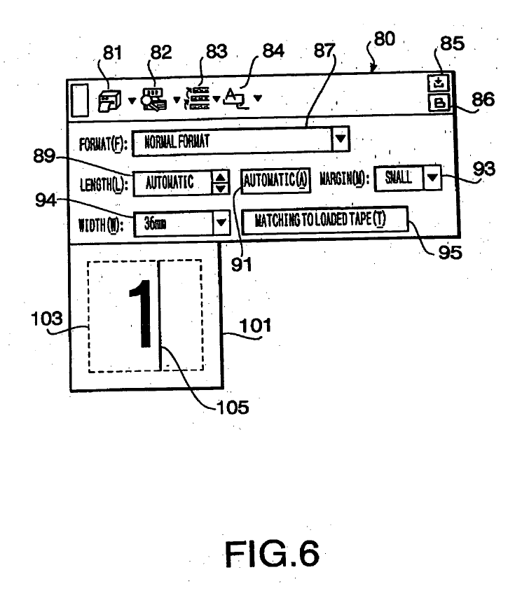

In this embodiment, an image of a tape as a print medium is displayed on the liquid crystal panel 5a of the liquid crystal display 5 as the background to the character string being edited. The length of the tape image 101 (see FIG. 6) displayed on the liquid crystal display 5 expands and contracts depending on the length of the character string being edited. For example, when the character string being edited is “abc”, the length of the tape image displayed on the liquid crystal display 5 is set to the length of the character string “abc” and right/left margins added together. When a new letter “d” is inputted, the tape image expands to the length of the character string “abcd” and right and left margins added together. On the other hand, when the character “c” is deleted, the tape image contracts to the length of the character string “ab” and right and left margins added together. When a character string across a plurality of lines is being edited, the length of the tape image displayed on the liquid crystal display 5 expands and contracts depending on the length of the longest line of the plurality of lines. By such display, the operator is allowed to easily check the actual layout of the printed tape regardless of the length of the inputted character string, without the need of performing a complicated manual operation.

In the tape image 101 displayed on the liquid crystal display 5, a caret 105 (see FIG. 6) as a pointer for indicating the insertion position of a newly inputted character in the tape image is displayed. In this embodiment, the caret is shown on the right side of the newly inputted character (in cases of horizontal writing) or on top of the character (in cases of vertical writing). The display position of the tape image is adjusted so that the caret will necessarily be shown in a predetermined range of the display area of the liquid crystal panel 5a of the liquid crystal display 5 (except the edge part of the display area) regardless of the length of the tape image. By such display, the operator is allowed to input characters while checking each inputted character being displayed at the caret position.

In this embodiment, the operator can designate one of the right end only (fixing the left end), the left end only (fixing the right end) and the right and left ends (fixing the center position) as a moving end which initially moves according to the expansion/contraction of the tape image 101, by use of the keyboard 6 or the mouse 7. By the function, the operator is allowed, for example, to decide the position of the tape image 101 properly based on constant use of the same initial moving end that has been designated, change the moving end of the tape image 101 to one that is easy to see, etc.

The size of each character in the character string displayed in the tape image 101 is set at a preset size corresponding to the tape width as long as the length of the character string does not exceed a length corresponding to a preset maximum tape image length. When the length of the character string exceeds the length corresponding to the preset maximum tape image length, the character size is set to a size corresponding to the length of the character string (corresponding exclusively to the number of characters when all the characters are of the same size) and the tape width. In a case where character strings across a plurality of lines is being edited, the character size is set to a size corresponding to the number of lines and the tape width as long as the length of the longest character string does not exceed the length corresponding to the preset maximum tape image length. When the length of the longest character string exceeds the length corresponding to the preset maximum tape image length, the character size is set to a size corresponding to the length of the longest character string, the number of lines and the tape width. As above, in this embodiment, the size of each character can be set to an optimum size that is determined in consideration of the length of the longest character string and the number of lines contained in the image.

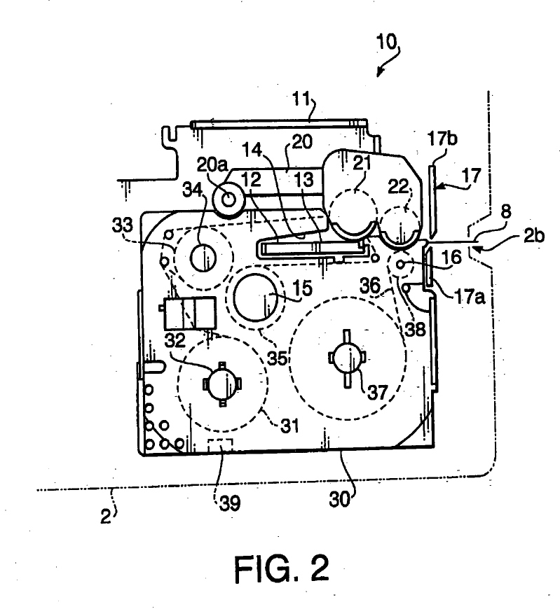

As shown in FIG. 1, the front face of the body 2a of the printer 2 has an outlet 2b for ejecting the tape 8. To the printer 2, a tape cassette 30 which will be explained later can be detachably attached. Further, the printer 2 is provided with a tape driving/printing mechanism 10 and a cutter 17 for cutting the tape (both shown in FIG. 2). The tape 8 pulled out from the tape cassette 30 and printed is cut by the cutter 17 and ejected from the outlet 2b.

FIG. 2 is a plan view for explaining the structure of the tape driving/printing mechanism 10 and the tape cassette 30 installed in the printer 2 whose external view is shown in FIG. 1. As shown in FIG. 2, the tape cassette 30 is detachably attached to a cassette storage frame 11 in the printer 2. The tape cassette 30 includes a tape spool 32 around which a transparent surface-layer tape 31 made of PET (polyethylene terephthalate) film, etc. is rolled, a ribbon supply spool 34 around which an ink ribbon 33 is rolled, a roll-up spool 35 for rolling up spent ink ribbon 33, a base material supply spool 37 around which a twofold tape 36, which is composed of a double-faced adhesive tape having adhesive layers on its both sides and having the same width as the surface-layer tape 31 and a releasing tape sticking to one side of the double-faced adhesive tape, is rolled with the releasing tape facing outward, and a joining roller 38 for joining the twofold tape 36 and the surface-layer tape 31 together. The spools and rollers are attached to the tape cassette 30 to rotate freely.

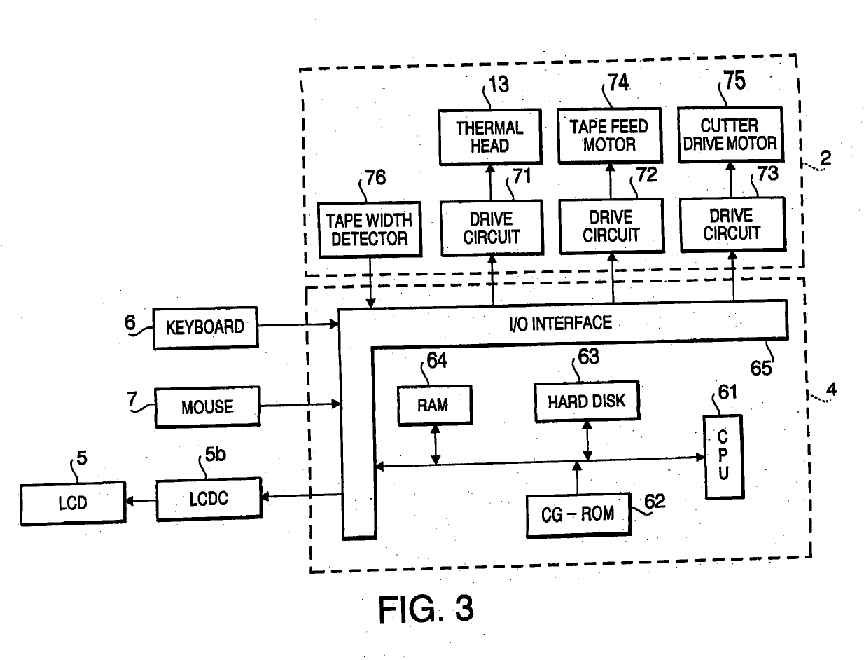

The tape cassette 30 has a projection part 39 (having a combination of three projections) to be used for detecting the width of the tape contained in the tape cassette 30. Meanwhile, the printer 2 is provided with a tape width detector 76 (see FIG. 3) for detecting the tape width based on the status of the projections of the projection part 39. The widths of available tapes include 6 mm, 9 mm, 12 mm, 18 mm, 24 mm and 36 mm, for example.

As shown in FIG. 2, an arm 20 is attached to the cassette storage frame 11 so as to swing around an axis 20a. To the tip of the arm 20, a platen roller 21 and a feed roller 22 (both having flexible material thereon) are attached to rotate freely. When the arm 20 swings to a limit in the clockwise direction, the platen roller 21 presses the surface-layer tape 31 and the ink ribbon 33 against a thermal head 13 which is mounted on a plate 12 (explained later), while the feed roller 22 presses the surface-layer tape 31 and the twofold tape 36 against the joining roller 38.

The plate 12 is provided vertically to the cassette storage frame 11. On the platen-roller side of the plate 12, the thermal head 13, having a lot of heating elements aligned in a direction perpendicular to FIG. 2, is placed. The plate 12 is inserted in a concavity 14 of the tape cassette 30 when the tape cassette 30 is loaded onto the proper position. To the cassette storage frame 11, a ribbon roll-up roller 15 and a joining roller driving roller 16 are also provided vertically. When the tape cassette 30 is loaded properly, the ribbon roll-up roller 15 and the joining roller driving roller 16 are inserted in the roll-up spool 35 and the joining roller 38, respectively.

When electric power is supplied to a tape feed motor 74 provided in the printer 2 (see FIG. 3), the roll-up spool 35 is revolved by the ribbon roll-up roller 15, while the joining roller 38, platen roller 21 and feed roller 22 are revolved by the joining roller driving roller 16. By the driving power of the revolved rollers, the surface-layer tape 31, ink ribbon 33 and twofold tape 36 in the tape cassette 30 are pulled out from spools and fed downstream. The surface-layer tape 31 and the ink ribbon 33 are overlaid on each other and then fed between the platen roller 21 and the thermal head 13. A lot of heating elements aligned in the thermal head 13 are selectively and intermittently energized while the surface-layer tape 31 and ink ribbon 33 are fed downstream being sandwiched between the platen roller 21 and thermal head 13, by which ink on the ink ribbon 33 is transferred to the surface-layer tape 31 dot by dot and thereby a desired dot image is formed on the surface-layer tape 31 as a mirror image. The ink ribbon 33 that passed the thermal head 13 is rolled up by the ribbon roll-up roller 15, while the surface-layer tape 31 is overlaid on the twofold tape 36. The surface-layer tape 31 and twofold tape 36 overlaid on each other are fed downstream being sandwiched between the feed roller 22 and the joining roller 38, by which the printed side of the surface-layer tape 31 firmly sticks to the twofold tape 36.

The tape 8, composed of the overlaid surface-layer tape 31 and twofold tape 36, shows the normal image of the printed dot image on a side opposite to the printed side of the surface-layer tape 31. The tape 8 is cut by the cutter 17 which is placed on the downstream side of the feed roller 22 and then ejected from the outlet 2b. The cutter 17 is a scissors-type cutter having a fixed blade 17a and a rotary blade 17b rotating relative to the fixed blade 17a. The rotary blade 17b is driven by a cutter drive motor 75 (see FIG. 3) to oscillate around its supporting point and cut the tape 8. The tape 8 cut off can be used as an adhesive label, which can be stuck to anything by stripping the releasing tape off.

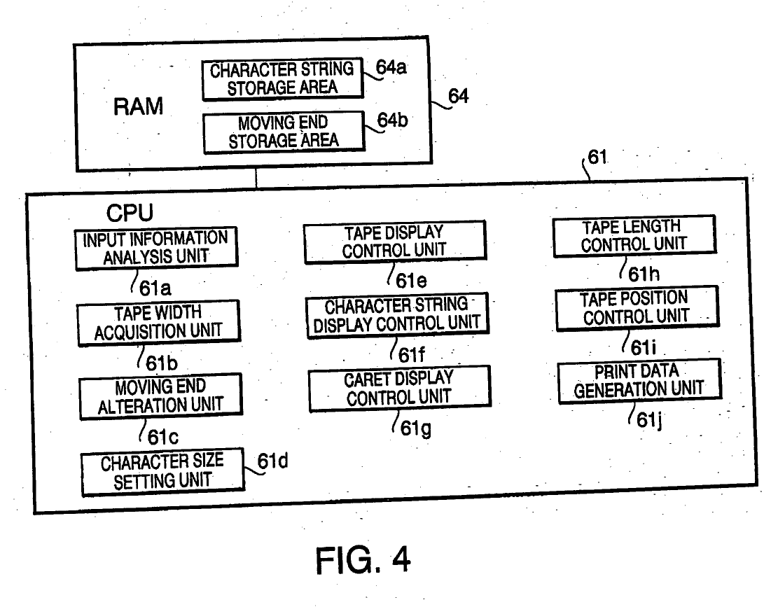

In the following, a control system of the computer 1 functioning as the character string editing device according to this embodiment will be described referring to FIG. 3 and FIG. 4. FIG. 3 is a block diagram for explaining the control system of the computer 1. FIG. 4 is a block diagram for explaining the operation of the CPU of the computer 1.

As shown in FIG. 3, the control main body 4 includes a CPU 61, a CG-ROM 62, a hard disk drive 63, a RAM (Random Access Memory) 64, and an input-output interface 65 (hereinafter referred to as “I/F 65”).

The I/F 65 of the control main body 4 is connected to the keyboard 6, the mouse 7 and an liquid crystal display controller (LCDC) 5b having a display RAM for outputting display data to the liquid crystal display 5. The I/F 65 is also connected to a drive circuit 71 for driving the thermal head 13 of the printer 2, a drive circuit 72 for driving the aforementioned tape feed motor 74, a drive circuit 73 for driving the aforementioned cutter drive motor 75, and the aforementioned tape width detector 76.

The CG-ROM 62 stores dot pattern data of a lot of characters as the targets of displaying or printing associating them with code data of the characters. The hard disk drive 63 stores various programs including an editor program as a character string editing program according to this embodiment, data tables, etc. as well as GUI (Graphic User Interface)-based OS (Operating System) software.

The RAM 64 includes a character string storage area 64a (see FIG. 4) for storing data of a character string inputted from the keyboard 6, and a moving end storage area 64b (see FIG. 4) for storing information to determine whether the moving end initially moving according to the expansion/contraction of the tape image displayed on the liquid crystal display 5 is the right end only, the left end only, or both right-and-left ends. The RAM 64 also includes an area for storing maximum printing area widths (maximum image formation area widths), which is predetermined as maximum width of the printing area in accordance with each tape width, associating them with the tape widths, a work area for the CPU 61, etc. The operator can arbitrarily rewrite memory contents of the moving end storage area 64b by operating the keyboard 6 or the mouse 7.

By installation of the aforementioned OS and the character string editing program, the CPU 61 functions as an input information analysis unit 61a, a tape width acquisition unit 61b, a moving end alteration unit 61c, a character size setting unit 61d, a tape display control unit 61e, a character string display control unit 61f, a caret display control unit 61g, a tape length control unit 61h, a tape position control unit 61i, and a print data generation unit 61j, as shown in FIG. 4.

Before explaining the functions of the CPU 61, for easy understanding of the functions, a description will be given on an edit screen of the editor displayed on the liquid crystal panel 5a of the liquid crystal display 5 with reference to FIG. 6. The edit screen 80 shown in FIG. 6 is a screen displayed during tape setting which will be described later. The display on the edit screen 80 includes a print button 81 which is selected and pressed when edited character string data is outputted to the printer 2 as print data, a display switching button 82 for switching between tape image display containing the inputted character string and text box display, a history display button 83 which is selected for seeing character strings that were printed out in the past, an edit switching button 84 for switching the edit screen 80 between the tape setting and text setting, a non-display button 85 for hiding the edit screen 80 and the tape image 101, an alignment button 86 for switching the moving end of the tape image, a list box 87 having a button for displaying a list of available formats (video cassette label, mini disc label, etc.) as a pull-down menu, a list box 89 having plus/minus buttons for changing the tape length, an image length automatic change ON/OFF button 91 for turning ON/OFF automatic changing of tape image length according to the length of the character string, a list box 93 having a button for displaying a list of available lengths of right/left tape margins as a pull-down menu, a list box 94 having a button for displaying a list of available tape widths as a pull-down menu, and an image width automatic change ON/OFF button 95 for turning ON/OFF automatic changing of the tape image width based on data acquired from the printer 2.

Meanwhile, when the text setting is selected by the edit switching button 84, list boxes, buttons, etc. for setting the font for the inputted character string, whether to underline or not, etc. are displayed on the edit screen 80 instead of the above list boxes 87, 89, 93 and 94 and ON/OFF buttons 91 and 95. The following explanation will be given assuming that the length of the tape image 101 is automatically changed according to the length of the character string when the image length automatic change ON/OFF button 91 has been pressed. The tape width can be changed not only by use of the list box 94 but also by dragging the upper and lower ends of the tape image 101 by the mouse 7. The list box 89 is disabled when the image length automatic change ON/OFF button 91 has been pressed. Similarly, the list box 94 is disabled when the image width automatic change ON/OFF button 95 has been pressed.

Below the edit screen 80, the tape image 101 is displayed. In the tape image 101, the inputted character string is shown with a character size that is determined as will be described later, according to the WYSIWYG (What You See Is What You Get) format using the font and style actually used for printing. At the character insertion position in the character string, the caret 105 is displayed blinking at preset time interval. The dotted box drawn in the tape image 101 indicates a maximum printing area 103 which is predetermined according to the tape width.

Returning to the explanation of the CPU 61, the input information analysis unit 61a analyzes information inputted by the operator using the keyboard 6 or mouse 7, based on a key press signal received from the keyboard 6 via the I/F 65 or a coordinate signal received from the mouse 7 via the I/F 65. The tape width acquisition unit 61b intermittently acquires the result of detection by the tape width detector 76 of the printer 2 (indicating status of the projections of the projection part 39 of the tape cassette 30) at preset intervals, and determines the width of the tape loaded in the tape cassette 30 based on the acquired detection result. Incidentally, the tape width acquisition unit 61b functions only when the image width automatic change ON/OFF button 95 has been pressed, i.e., only when the automatic changing of tape image width based on data acquired from the printer 2 has been turned ON.

The moving end alteration unit 61c cyclically rewrites the memory contents of the moving end storage area 64b each time when the alignment button 86 is pressed. That is, pressing the alignment button 86 alters the moving end of the tape image cyclically as “left end only” → “right end only” → “both right-and-left ends” → “left end only” → . . . .

In the case where two or more lines of character strings are being edited, the character size setting unit 61d determines whether or not the length of the longest character string of the plurality of lines exceeds the length corresponding to the preset maximum tape image length (300 mm in this embodiment) based on the data stored in the character string storage area 64a as mentioned above. If the length of the longest character string does not exceed the length corresponding to the preset maximum tape image length, the character size setting unit 61d sets the character size depending on the number of lines (obtained from the number of line feed codes stored in the character string storage area 64a) and the tape width (obtained by the tape width acquisition unit 61b). If exceeds, the character size setting unit 61d sets the character size depending on the length of the longest character string, the number of lines and the tape width. Therefore, when the tape width remains constant, the character size gradually decreases as the longest character string gets longer or the number of lines increases.

The tape display control unit 61e controls display of the tape image 101, having the width determined by the tape width acquisition unit 61b, on the liquid crystal panel 5a of the liquid crystal display 5. The character string display control unit 61f controls display of the one or more lines of character strings stored in the character string storage area 64a of the RAM 64 in the tape image 101. The caret display control unit 61g controls display of the caret 105 at a position in the tape image 101 designated by the operator, according to the result of analysis by the input information analysis unit 61a.

The tape length control unit 61h controls the tape display control unit 61e so that the tape image will expand and contract depending on the length of the longest character string of the one or more lines of character strings stored in the character string storage area 64a, within the aforementioned maximum length. The tape position control unit 61i controls the tape display control unit 61e so as to properly set the position of the tape image 101 so that the caret 105 will constantly be displayed in the predetermined range of the display area of the liquid crystal panel 5a and the position of the tape image 101 on the liquid crystal panel 5a will be determined based on the memory contents of the moving end storage area 64b. The print data generation unit 61j generates print data to be used for tape printing by the printer 2 based on the memory contents of the character string storage area 64a, etc. and using the data stored in the CG-ROM 62.

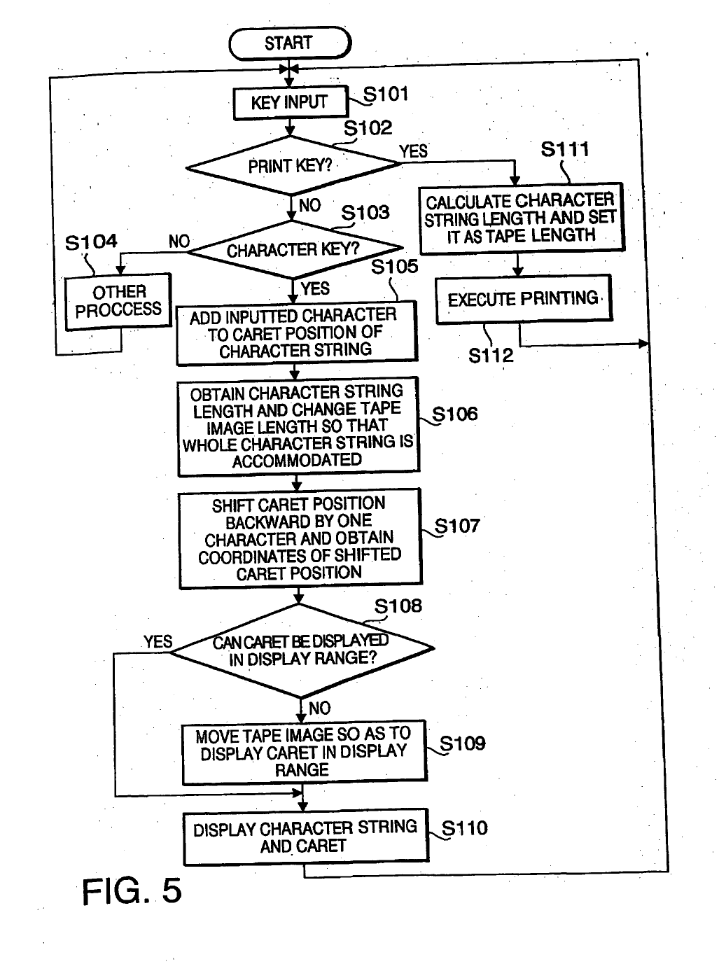

In the following, the operation of the computer 1 and the printer 2 will be described referring to FIG. 5. FIG. 5 is a flow chart for explaining the operation of the computer 1 and printer 2 in the character string editing process.

When the input information analysis unit 61a detects the occurrence of an input based on the key press signal or the coordinate signal supplied from the keyboard 6 or mouse 7 via the I/F 65 in step S101, the input information analysis unit 61a determines whether or not the input is the pressing of the print button 81 on the edit screen 80 in step S102. When it is determined that the input is not the pressing of the print button 81 (S102: NO), the process proceeds to step S103.

In step S103, the input information analysis unit 61a determines whether or not the input is the pressing of a character key of the keyboard 6. When it is determined that the input is not the pressing of a character key (S103: NO), the process proceeds to step S104. In step S104, a process corresponding to the type of input (changing the font or tape width, moving the caret 105, etc.) is carried out and thereafter the process returns to the step S101.

When it is determined that the input is the pressing of a character key (S103: YES), the process proceeds to step S105. In step S105, data of the character inputted in step S101 is stored in the character string storage area 64a of the RAM 64. The character data inputted here is inserted into a position in the character string data corresponding to the caret position in the tape image 101.

Next, in step S106, the character size setting unit 61d determines the character size based on the number of lines of the character strings, tape width, and the length of the character string compared with that of the tape image 101. Subsequently, the tape length control unit 61h controls the tape display control unit 61e so that the length of the tape image 101 will be a length that just accommodates the longest character string in the one or more lines of character strings stored in the character string storage area 64a together with the margins, taking the determined character size in consideration. Further, the tape position control unit 61i determines the position of the tape image 101 on the liquid crystal panel 5a based on the information stored in the moving end storage area 64b, by which the tape image 101, having the moving end(s) at its right end, left end or both right-and-left ends, expands and contracts.

In the next step S107, position coordinates of the caret 105, which has been shifted on the liquid crystal panel 5a to the right or downward by one character width due to the character key input in step S101, are obtained by the caret display control unit 61g. Subsequently, in step S108, the caret display control unit 61g determines whether or not the position coordinates of the caret 105 obtained in step S107 are within the predetermined range of the display area of the liquid crystal panel 5a.

When the caret 105 can not be displayed in the predetermined range (S108: NO), the process proceeds to step S109. In step S109, the tape position control unit 61i which received a signal from the caret display control unit 61g controls the tape display control unit 61e so that the caret 105 can be displayed in the predetermined range of the display area of the liquid crystal panel 5a, by which the tape image 101 is moved to a proper position where the caret 105 is displayed in the predetermined range.

Then, in step S110, the character string stored in the character string storage area 64a and the caret 105 are displayed under the control of the character string display control unit 61f and the caret display control unit 61g respectively, together with the tape image 101 which has been moved in step S109 as the background. Thereafter, the process returns to the step S101.

When it is determined that the caret 105 can be displayed (S108: YES), the process proceeds to the step S110 without moving the tape image 101 in step S109, and the character string and the caret are displayed.

When it is determined in step S102 that the input is the pressing of the print button 81 (S102: YES), the process proceeds to step S111. In step S111, the print data generation unit 61j generates the print data to be used for tape printing in the printer 2 based on the memory contents of the character string storage area 64a, etc. and using the data stored in the CG-ROM 62, and outputs the print data to the printer 2. Then, in step S112, the printer 2 executes the tape printing by use of the print data supplied from the computer 1.

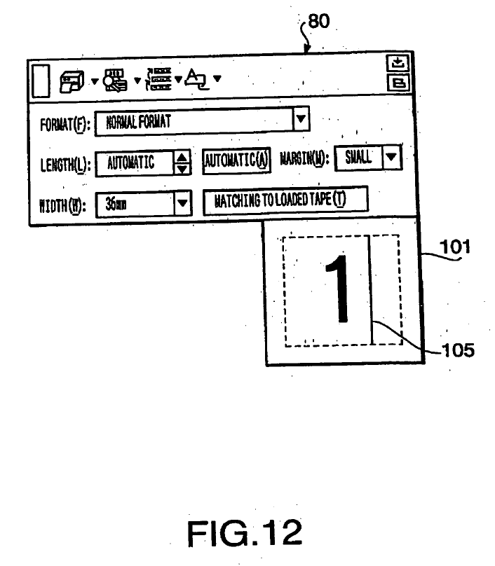

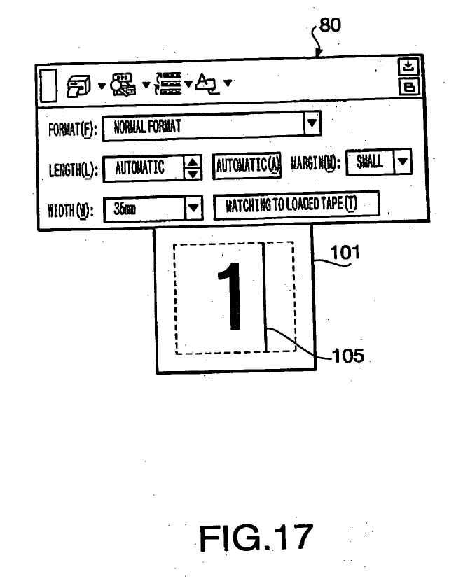

In the following, concrete examples of character string editing in accordance with the embodiment will be explained with reference to FIG. 6 through FIG. 20. FIGS. 6-11 depict examples of display on the liquid crystal panel 5a when the right end of the tape image is the moving end, FIGS. 12-16 depict examples of display when the left end of the tape image is the moving end, and FIGS. 17-20 depict examples of display when both right-and-left ends of the tape image are the moving ends.

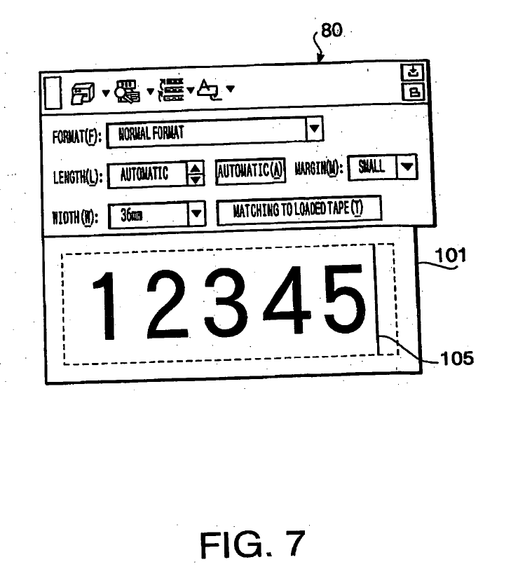

In the case where the moving end of the tape image is the right end only, the left end of the tape image 101 is aligned with the left end of the edit screen 80 in the default setting. As shown in FIGS. 6 and 7, each time a character is inputted from the keyboard 6, the tape display control unit 61e is controlled by the tape length control unit 61h and the tape position control unit 61i, by which the tape image 101 expands to the right with its left end fixed at a point on the liquid crystal panel 5a. Also, the caret 105 moves rightward each time a character is inputted.

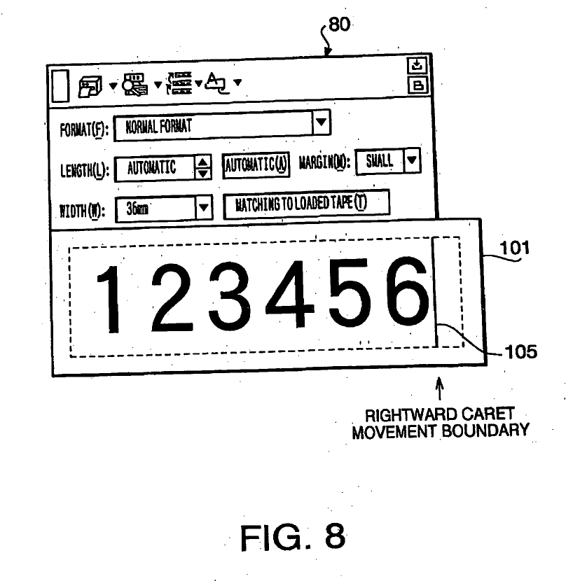

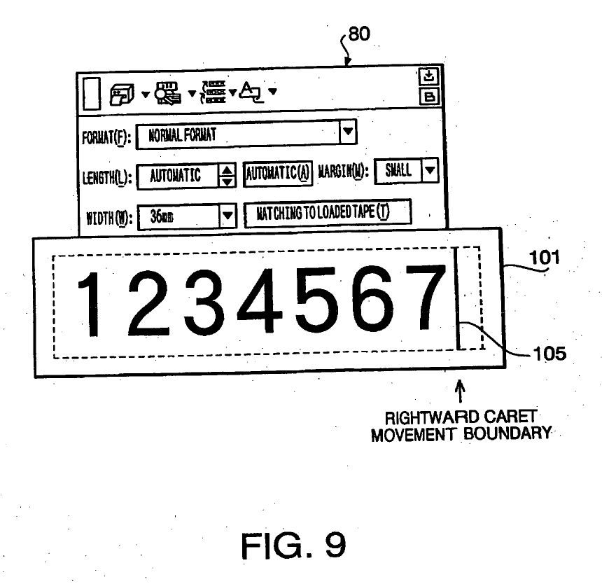

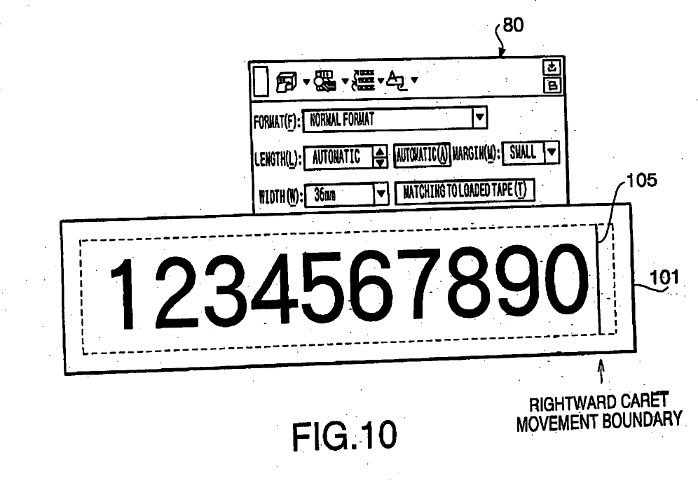

However, when the caret 105 reaches a rightward caret movement boundary which is shown in FIG. 8 (identical with the right end of the predetermined range of the display area of the liquid crystal panel 5a), the caret 105 stops moving rightward. Thereafter the tape image 101 expands to the left as characters are inputted, with its right end fixed as shown in FIG. 9 and FIG. 10. Incidentally, while FIGS. 6-10 are depicting cases where the caret 105 is immediately on the right side of the rightmost character of the character string, the above explanation also applies to other cases regardless of the caret position in the character string. In cases where the caret 105 is on the left side of the rightmost character of the character string, when the caret 105 reaches the rightward caret movement boundary, characters on the right side of the caret 105 protrude rightward and disappear from the display area of the liquid crystal panel 5a.

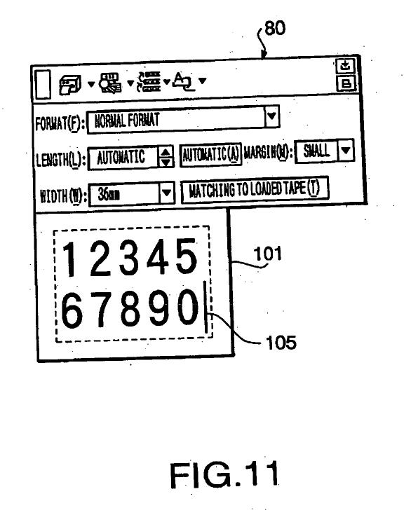

In the examples of FIGS. 6-10, the character string is only one line and the length of the character string does not exceed a length corresponding to the maximum length of the tape image 101, and therefore, the character size setting unit 61d sets the size of each character at the maximum size corresponding to the tape width. However, even if the length of the character string does not exceed the length corresponding to the maximum length of the tape image 101, when the number of lines increases to two as shown in FIG. 11, the character size setting unit 61d sets the character size smaller than that shown in FIGS. 6-10.

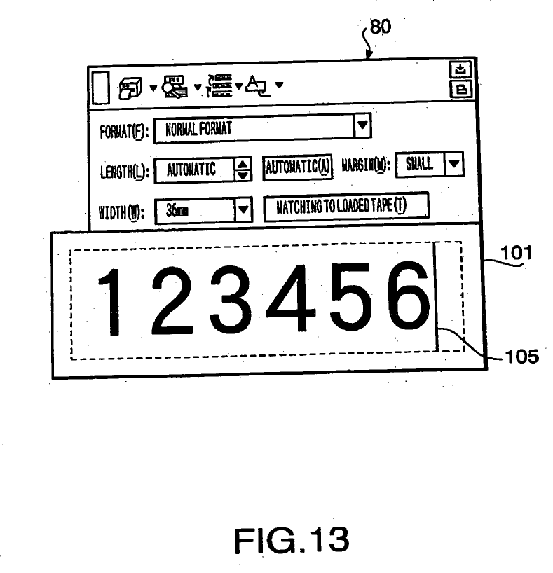

In the case where the moving end of the tape image is the left end only, the right end of the tape image 101 is aligned with the right end of the edit screen 80 in the default setting. As shown in FIGS. 12 and 13, each time a character is inputted from the keyboard 6, the tape display control unit 61e is controlled by the tape length control unit 61h and the tape position control unit 61i, by which the tape image expands to the left with its right end fixed at a point on the liquid crystal panel 5a. In this case, the caret 105 on the liquid crystal panel 5a does not move and stands still even if characters are inputted.

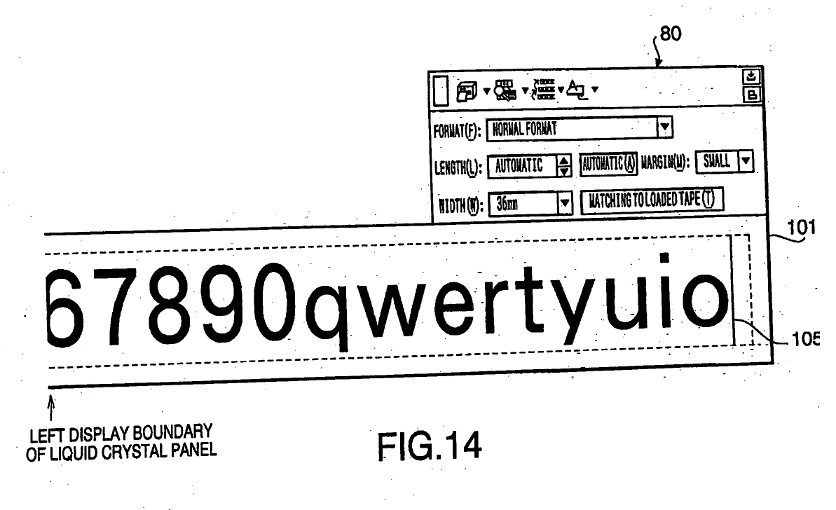

The left end of the tape image 101 eventually reaches the left end of the predetermined range of the display area of the liquid crystal panel 5a (a left display boundary of the liquid crystal panel). However, the caret 105 is fixed and thus never goes out of the display area of the liquid crystal panel 5a even if the tape image 101 keeps on expanding to the left. Thus, when the next character is inputted, the left end of the tape image 101 and the leftmost character of the character string protrude leftward from the display area and disappear. Thereafter, each time a new character is inputted, characters of the character string disappear from the display area one by one from the left end as shown in FIG. 14. Incidentally, while FIGS. 12-14 are depicting cases where the caret 105 is immediately on the right side of the rightmost character of the character string, the above explanation also applies to other cases regardless of the caret position in the character string.

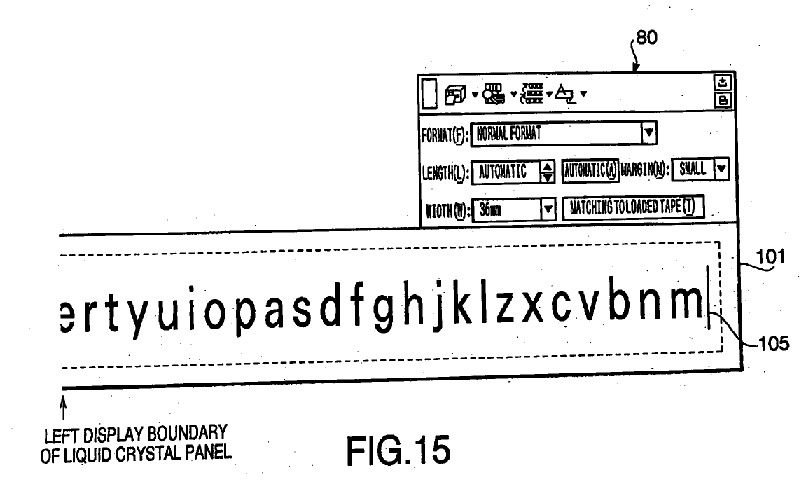

In the examples of FIGS. 12-14, the character string is only one line and the length of the character string does not exceed the length corresponding to the maximum length of the tape image 101, and therefore, the character size setting unit 61d sets the size of each character at the maximum size corresponding to the tape width. However, even if the number of lines of the character string remains one, when the length of the character string exceeds the length corresponding to the maximum length of the tape image 101 as shown in FIG. 15, the character size setting unit 61d sets the character size smaller than that shown FIGS. 12-14 as the character string gets longer. The character size determined by the character size setting unit 61d gets smaller as the character string gets longer.

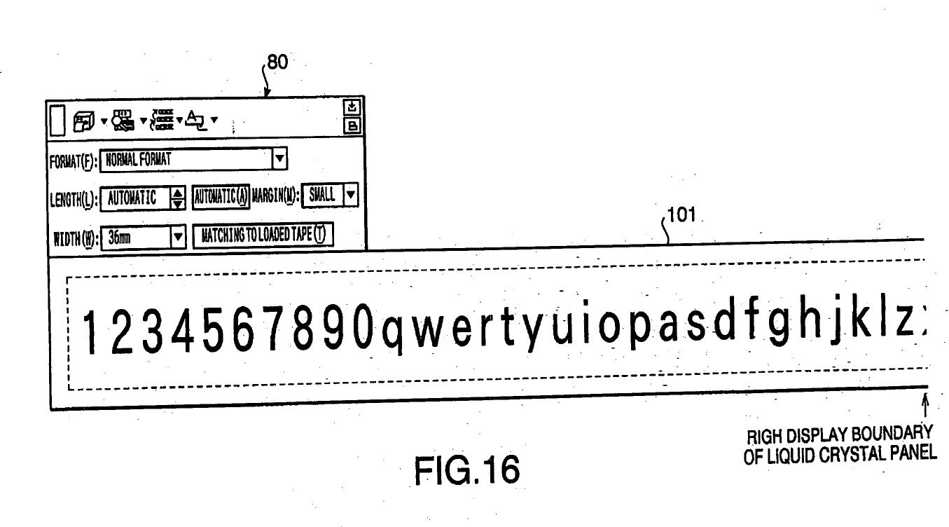

As shown in FIG. 15, when left part of the tape image 101 goes out of the predetermined range of the display area of the liquid crystal panel 5a, the operator can not see hidden characters located in the vicinity of the left end of the character string. Therefore, in this embodiment, if the alignment button 86 is pressed by the mouse 7 and the memory contents of the moving end storage area 64b are altered by the moving end alteration unit 61c into “the moving end is the right end only”, the tape position control unit 61i controls the tape display control unit 61e so that the left end of the tape image 101 will be aligned with the left end of the edit screen 80 as shown in FIG. 16. In this case, the tape position control unit 61i does not consider whether the caret 105 will be shown in the display area of the liquid crystal panel 5a. Thus, when the tape image 101 is relatively long, right part of the tape image 101 protrudes from the left end of the predetermined range of the display area of the liquid crystal panel 5a (the right display boundary of the liquid crystal panel) and the caret 105 on the right side of the boundary is not displayed on the liquid crystal panel 5a. As above, by this embodiment, even in the editing of a relatively long character string, the operator is allowed to instantly see the part of the tape image 101 protruding and disappearing from the display area of the liquid crystal panel 5a, by pressing the alignment button 86.

Incidentally, the state of FIG. 16 where the caret 105 is not displayed is released when some kind of event such as a character input, etc. occurs. Processes similar to that explained above referring to FIGS. 15 and 16 also occur when “the moving end of the tape image 101 is the right end only” is switched into “the moving end of the tape image 101 is the left end only” or when “the moving end of the tape image 101 is the right end only” is switched into “the moving end of the tape image 101 is the both right-and-left ends”. Also in these cases, there is a possibility that the caret 105 is not displayed just after the alignment button 86 is pressed, since the tape position control unit 61i does not consider whether the caret 105 will be shown in the display area of the liquid crystal panel 5a.

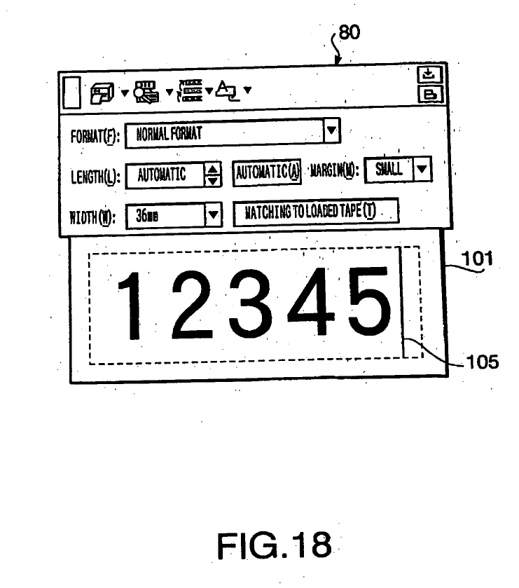

In the case where the moving end of the tape 101 is the both right-and-left ends, the center of the tape image 101 in the longitudinal direction is placed at the center of the edit screen 80 in the longitudinal direction of the edit screen 80 in the default setting. As shown in FIGS. 17 and 18, each time a character is inputted from the keyboard 6, the tape display control unit 61e is controlled by the tape length control unit 61h and the tape position control unit 61i, by which the tape image 101 expands in both of the rightward and the leftward directions. In this case, the caret 105 on the liquid crystal panel 5a moves rightward as the characters are inputted.

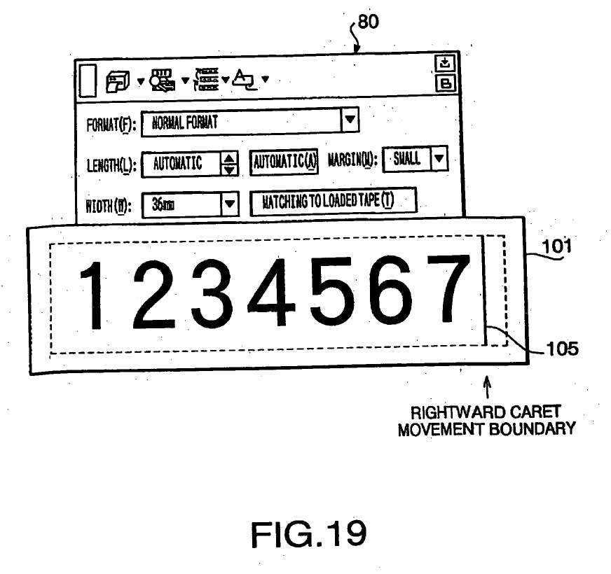

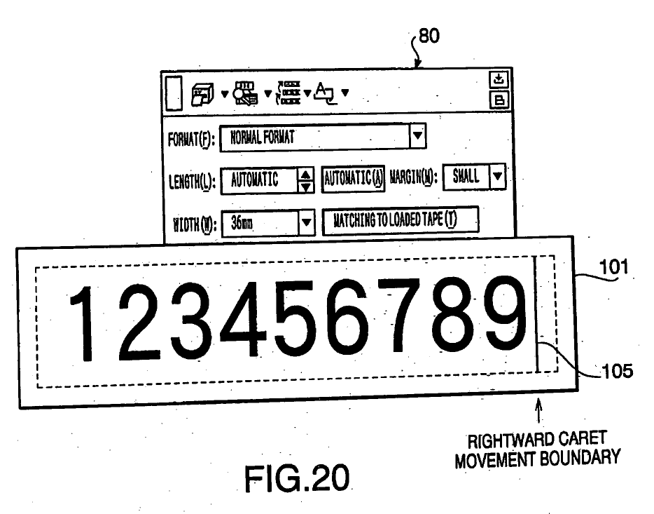

However, when the caret 105 reaches the rightward caret movement boundary shown in FIG. 19, the caret 105 stops moving rightward. Thereafter the tape image 101 expands to the left as characters are inputted, with its right end fixed as shown in FIG. 20. Incidentally, while FIGS. 17-20 are depicting cases where the caret 105 is immediately on the right side of the rightmost character of the character string, the above explanation also applies to other cases regardless of the caret position in the character string. In cases where the caret 105 is on the left side of the rightmost character of the character string, when the caret 105 reaches the rightward caret movement boundary, characters on the right side of the caret 105 protrude rightward and disappear from the display area of the liquid crystal panel 5a.

While the present invention has been described with reference to the particular illustrative embodiments, it is not to be limited by those embodiments, but the change of design of the embodiment can be made without departing from the scope and spirit of the present invention. For example, while in the above embodiment the computer 1 and the printer 2 are connected to each other through the cable 3, the functions described above can of course be applied to a stand-alone machine. While the above embodiment described a case where the character string edited by the user is printed on a tape, the present invention can of course be applied to a variety of cases such as a case where the image formation medium is stamp material and the edited character string is formed on the stamp material for making a stamp.

The program for letting the CPU execute the above processes may be stored in a record medium such as a CD-ROM, by which the sales of the program executing the above processes is facilitated.

A character string editing device according to the present invention further includes: a pointer display control means which performs control for displaying a pointer on the display, the pointer indicating a position at which a character newly stored in the character string storage means is inserted into the image of the image formation medium displayed on the display; and a medium position control means which controls the medium display control means so as to set the position of the image so that the pointer will be displayed constantly in a predetermined range of a display area of the display.

According to the invention described above, the pointer such as a caret can be displayed on the display constantly and thereby the operator is allowed to input letters checking every letter inputted.

A character string editing device according to the present invention further includes a moving end storage means for storing information on whether a moving end of the image initially moving according to the expansion/contraction of the image is the right end only, the left end only, or both right-and-left ends. The medium position control means controls the medium display control means so that the position of the image on the display will be set based on memory contents of the moving end storage means.

According to the invention described above, the position of the image can be determined properly in accordance with constant use of the same initial moving end.

In a character string editing device according to the present invention, when the moving end storage means holds information indicating that the moving end of the image is the right end only, the medium position control means controls the medium display control means so that only the right end of the image will expand and contract until the pointer reaches the right end of the predetermined range, while controlling the medium display control means so that only the left end of the image will expand and contract after the pointer reaches the right end of the predetermined range.

In a character string editing device according to the present invention, when the moving end storage means holds information indicating that the moving end of the image is the left end only, the medium position control means controls the medium display control means so that only the left end of the image will expand and contract.

In a character string editing device according to the present invention, when the moving end storage means holds information indicating that the moving end of the image is the both right-and-left ends, the medium position control means controls the medium display control means so that both right-and-left ends of the image will expand and contract until the pointer reaches the right end of the prescribed range, while controlling the medium display control means so that only the left end of the image will expand and contract after the pointer reaches the right end of the predetermined range.

According to the present invention described above, in each case where the moving end of the image is the right end only, the left end only or the both right-and-left ends, the image can be properly expanded and contracted depending on the number of letters while ensuring constant display of the pointer in the predetermined range of the display area of the display.

A character string editing device according to the present invention further includes a moving end alteration means for rewriting the memory contents of the moving end storage means based on input information from a user interface.

According to the present invention described above, the moving end of the image can be changed by the operator to one that is easy to see.

In a character string editing device according to the present invention, at a stage when the memory contents of the moving end storage means are rewritten by the moving end alteration means, the medium position control means controls the medium display control means so that the image will be displayed at a proper position based on the memory contents of the moving end storage means regardless of whether or not the pointer is displayed in the predetermined range.

According to the present invention described above, part of the image protruding and disappearing from the display area of the display can instantly be shown to the operator in response to the operation of the user interface.

A character string editing device according to the present invention further includes a character size setting means which sets the size of each character depending on the number of lines of the character strings when the length of the longest character string in the one or more lines of character strings stored in the character string storage means does not exceed a length corresponding to a maximum length of the image, while setting the size of each character depending on the length of the longest character string and the number of lines of the character strings when the length of the longest character string exceeds the length corresponding to the maximum length of the image.

According to the present invention described above, the size of each character can be set to an optimum size that is determined in consideration of the length of the longest character string and the number of lines of the character strings contained in the image.

According to the present invention, there is provided a character string editing program for editing a character string to be formed on an image formation medium, which instruct a computer to function as the above character string editing devices to achieve the same effects. The programs can be distributed by storing them in removable record mediums such as CD-ROMs or fixed record mediums such as HDDs or through communications networks such as the Internet using wired or wireless telecommunication devices.

According to the present invention described above, the image of the image formation medium expands or contracts to a proper length corresponding to the length of the character string, by which the operator is allowed to easily check the actual layout of the printed tape without the need of performing a complicated manual operation regardless of the length of the inputted character string.

Further, the pointer such as a caret can be displayed on the display constantly and thereby the operator is allowed to input letters checking every letter inputted. The operator is also allowed to decide the position of the image properly in accordance with constant use of the same initial moving end.

According to the present invention described above, in each case where the moving end of the image is the right end only, the left end only or the both right-and-left ends, the image can be properly expanded and contracted depending on the number of letters while ensuring constant display of the pointer in the predetermined range of the display area of the display.

According to the present invention described above, the moving end of the image can be changed by the operator to one that is easy to see. Further, part of the image protruding and disappearing from the display area of the display can instantly be shown to the operator in response to the operation of the user interface. Further, the size of each character can be set to an optimum size that is determined in consideration of the length of the longest character string and the number of lines of the character strings contained in the image.

1. A character string editing device for editing a character string to be formed on an image formation medium, comprising:
a medium display control means which performs control for displaying an image of the image formation medium on a display;
a character string storage means for storing one or more lines of character strings;
a character string display control means which performs control for displaying the one or more lines of character strings stored in the character string storage means in the image displayed on the display; and
a medium length control means for controlling the medium display control means so that the image will expand and contract depending on the length of the longest character string in the one or more lines of character strings stored in the character string storage means.

2. The character string editing device according to claim 1, further comprising:
a pointer display control means which performs control for displaying a pointer on the display, the pointer indicating a position at which a character newly stored in the character string storage means is inserted into the image of the image formation medium displayed on the display; and
a medium position control means which controls the medium display control means so as to set the position of the image so that the pointer will be displayed constantly in a predetermined range of a display area of the display.

3. The character string editing device according to claim 2, further comprising a moving end storage means for storing information on whether a moving end of the image initially moving according to the expansion/contraction of the image is a right end only, a left end only, or both right-and-left ends,
wherein the medium position control means controls the medium display control means so that the position of the image on the display will be set based on memory contents of the moving end storage means.

4. The character string editing device according to claim 3, wherein when the moving end storage means holds information indicating that the moving end of the image is the right end only, the medium position control means controls the medium display control means so that only the right end of the image will expand and contract until the pointer reaches the right end of the predetermined range, while controlling the medium display control means so that only the left end of the image will expand and contract if the pointer further moves to cross the right end of the predetermined range.

5. The character string editing device according to claim 3, wherein when the moving end storage means holds information indicating that the moving end of the image is the left end only, the medium position control means controls the medium display control means so that only the left end of the image will expand and contract.

6. The character string editing device according to claim 3, wherein when the moving end storage means holds information indicating that the moving end of the image is the both right-and-left ends, the medium position control means controls the medium display control means so that both right-and-left ends of the image will expand and contract until the pointer reaches the right end of the predetermined range, while controlling the medium display control means so that only the left end of the image will expand and contract if the pointer further moves to cross the right end of the predetermined range.

7. The character string editing device according to claim 3, further comprising a moving end alteration means for rewriting the memory contents of the moving end storage means based on input information from a user interface.

8. The character string editing device according to claim 7, wherein at a stage when the memory contents of the moving end storage means are rewritten by the moving end alteration means, the medium position control means controls the medium display control means so that the image will be displayed at a proper position corresponding to the memory contents of the moving end storage means regardless of whether or not the pointer is displayed in the predetermined range.

9. The character string editing device according to claim 1, further comprising a character size setting means which sets the size of each character depending on the number of lines of the character strings when the length of the longest character string in the one or more lines of character strings stored in the character string storage means does not exceed a length corresponding to a maximum length of the image, while setting the size of each character depending on the length of the longest character string and the number of lines of the character strings when the length of the longest character string exceeds the length corresponding to the maximum length of the image.

10. The character string editing device according to claim 9, wherein the character size setting means sets the character size so that the size of each character when the length of the character string exceeds the length corresponding to the maximum length of the image will be smaller than the size of each character when the length of the character string does not exceed the length corresponding to the maximum length of the image.

11. The character string editing device according to claim 8, wherein the medium position control means includes an alignment means which changes the moving end of the image to the opposite right end only when the moving end storage means holds information indicating that the moving end of the image initially moving according to the expansion/contraction of the image is the left end only.

12. A character string editing program for editing a character string to be formed on an image formation medium, the character string editing program instructing a computer to function as:
a medium display control means which performs control for displaying an image of the image formation medium on a display;
a character string storage means for storing one or more lines of character strings;
a character string display control means which performs control for displaying the one or more lines of character strings stored in the character string storage means in the image displayed on the display; and
a medium length control means for controlling the medium display control means so that the image will expand and contract depending on the length of the longest character string in the one or more lines of character strings stored in the character string storage means.

13. The character string editing program according to claim 12, further instructing the computer to function as:
a pointer display control means which performs control for displaying a pointer on the display, the pointer indicating a position at which a character newly stored in the character string storage means is inserted into the image of the image formation medium displayed on the display; and
a medium position control means which controls the medium display control means so as to set the position of the image so that the pointer will be displayed constantly in a predetermined range of a display area of the display.

14. The character string editing program according to claim 13, further instructing the computer to function as a moving end storage means for storing information on whether a moving end of the image initially moving according to the expansion/contraction of the image is a right end only, a left end only, or both right-and-left ends,
wherein the medium position control means controls the medium display control means so that the position of the image on the display will be set based on memory contents of the moving end storage means.

15. The character string editing program according to claim 14, wherein when the moving end storage means holds information indicating that the moving end of the image is the right end only, the medium position control means controls the medium display control means so that only the right end of the image will expand and contract until the pointer reaches the right end of the predetermined range, while controlling the medium display control means so that only the left end of the image will expand and contract if the pointer further moves to cross the right end of the predetermined range.

16. The character string editing program according to claim 14, wherein when the moving end storage means holds information indicating that the moving end of the image is the left end only, the medium position control means controls the medium display control means so that only the left end of the image will expand and contract.

17. The character string editing program according to claim 14, wherein when the moving end storage means holds information indicating that the moving end of the image is the both right-and-left ends, the medium position control means controls the medium display control means so that both right-and-left ends of the image will expand and contract until the pointer reaches the right end of the prescribed range, while controlling the medium display control means so that only the left end of the image will expand and contract if the pointer further moves to cross the right end of the predetermined range.

18. The character string editing program according to claim 14, further instructing the computer to function as a moving end alteration means for rewriting the memory contents of the moving end storage means based on input information from a user interface.

19. The character string editing program according to claim 18, wherein at a stage when the memory contents of the moving end storage means are rewritten by the moving end alteration means, the medium position control means controls the medium display control means so that the image will be displayed at a proper position based on the memory contents of the moving end storage means regardless of whether or not the pointer is displayed in the predetermined range.

20. The character string editing program according to claim 12, further instructing the computer to function as a character size setting means which sets the size of each character depending on the number of lines of the character strings when the length of the longest character string in the one or more lines of character strings stored in the character string storage means does not exceed a length corresponding to a maximum length of the image, while setting the size of each character depending on the length of the longest character string and the number of lines of the character strings when the length of the longest character string exceeds the length corresponding to the maximum length of the image.
